(19) United States
(12) Patent Application Publication
(10) Pub. No.: US 2024/0218158 A1
(43) Pub. Date: Jul. 4, 2024

(54) ASA POLYMER COMPOSITION WITH OPTIMISED UV STABILITY AND GOOD TOUGHNESS-STIFFNESS BALANCE

(71) Applicant: INEOS STYROLUTION GROUP GMBH, Frankfurt am Main (DE)

(72) Inventors: Norbert NIESSNER, Friedelsheim (DE); SangJun AHN, Seoul (KR)

(21) Appl. No.: 17/914,206

(22) PCT Filed: Mar. 23, 2021
(86) PCT No.: PCT/EP2021/057397

§ 371 Date: Sep. 23, 2022

(30) Foreign Application Priority Data
Mar. 24, 2020 (EP) 20165145.2

(51) Int. Cl. C08K 5/3435; C08K 3/04; C08K 5/00; C08K 5/3475; C08L 25/12; C08L 51/04

(52) U.S. Cl. CPC C08K 5/3435; C08K 3/04; C08K 5/005; C08K 5/3475; C08L 25/12; C08L 51/04; C08L 2201/08; C08L 2205/025; C08L 2207/04

(57) ABSTRACT

A thermoplastic acrylate-styrene-acrylonitrile (ASA) copolymer composition for the production of moldings. The composition comprises:
10-89.7% by weight of a copolymer A1 consisting of styrene and acrylonitrile,
10-89.7% by weight of at least one graft copolymer A2 having an average particle size of 80-800 nm, consisting of a rubber-like base substance having T_{g}<0° C. and at least one graft shell,
0.1-2% by weight of at least one sterically hindered amine B1,
0-2% by weight of at least one sterically hindered amine B2,
0-2% by weight of at least one UV-A absorber B3,
0.1-3% by weight of at least one carbon black component CB, and
0-5% by weight of one or more further additives C.

The thermoplastic acrylate-styrene-acrylonitrile copolymer composition after the production of moldings results in at least one sterically hindered amine (B1, B2) being present on the surface of a molding after 500 h of artificial weathering in accordance with standard EN ISO 4892 in a higher amount than in a molding before the artificial weathering.

The invention relates to stabilized thermoplastic compositions based on acrylate-styrene-acrylonitrile (ASA) copolymers having improved surface properties, including improved stability of the surface quality of moldings when stored in a warm and humid environment. The invention relates also to the use of the compositions, to the production thereof, and to moldings (e.g. shaped bodies) produced from the thermoplastic ASA compositions.

It is known that styrene-acrylonitrile copolymers (SANs) and/or alpha-methylstyrene-acrylonitrile copolymers (AMSANs) can be modified with a view to improving impact strength by incorporating graft rubbers, for example crosslinked polyacrylate rubbers.

Such acrylate-styrene-acrylonitrile (ASA) copolymers have for many years been used in large amounts as thermoplastic molding compounds for the production of moldings of all kinds. In principle, such impact-modified SAN molding compounds can be produced by graft polymerization of styrene and acrylonitrile in the presence of a graft rubber and/or by subsequent mixing of a graft rubber (graft latex) with a separately produced polymeric styrene-acrylonitrile matrix. The spectrum of properties of the molding compounds and of the moldings produced therefrom can be varied within wide ranges. Examples of commercially available ASA copolymers are products of the Luran® S series (from INEOS Styrolution, Frankfurt). Also available, for example under the name Luran® SC (INEOS Styrolution), are blends of ASA and polycarbonate (ASA/PC). Blends of ASA and polyamide (ASA/PA) are available for example under the name Terblend® S (INEOS Styrolution).

The average particle size of the graft rubber in the ASA compositions can be selectively adjusted, since the size of the rubber particles has a significant influence on the physical properties of the subsequent thermoplastic moldings. This is described for example in WO 2015/078751. Besides the advantageous mechanical properties of ASA copolymer products, such as high toughness (impact strength, notched impact strength), high elasticity (E modulus), good processability (thermoplastic flowability, in particular a suitable melt flow index, MVR), and high heat resistance, what is of particular importance are the surface properties such as gloss, smoothness, homogeneity, and uniform appearance.

ASA molding compounds and the moldings produced therefrom should in particular permit a high degree of surface homogeneity, i.e. a surface without defects such as depressions, cracks or salt deposits.

For fields of application in the automotive sector for example, it is essential to maintain good surface homogeneity under warm and humid ambient conditions. A warm and humid environment generally refers to conditions in which the temperature and humidity are above the usual values of 15 to 25° C. and 30 to 60% relative humidity. In addition, warm and humid ambient conditions can in particular involve direct contact of the surface concerned with, for example, water of condensation.

The invention accordingly provides a thermoplastic acrylate-styrene-acrylonitrile (ASA) copolymer composition that is particularly suitable for the production of moldings.

The composition comprises the following components (or consists of the following components):
10-89.7% by weight, based on the total composition, of a copolymer A1,
10-89.7% by weight, based on the total composition, of at least one graft copolymer A2 having an average particle size of 80 to 800 nm,
0.1-2% by weight, based on the total composition, of at least one sterically hindered amine (HALS) B1,
0-2% by weight, based on the total composition, of at least one sterically hindered amine (HALS) B2 that is different from B1,
0-2% by weight, based on the total composition, especially 0.1-2% by weight, of at least one UV-A absorber B3,
0.1-3% by weight, based on the total composition, of at least one carbon black component CB, and
0-5% by weight, based on the total composition, especially 0.1-5% by weight, of one or more further additives C that is/are different from B1, B2, B3, and CB,
wherein the thermoplastic acrylate-styrene-acrylonitrile copolymer composition after the production of moldings, especially by injection molding, results in at least one sterically hindered amine (B1, B2) being present on the surface of a molding after 500 h of artificial weathering in accordance with standard EN ISO 4892 in a higher amount than in a molding before the artificial weathering.

After the production of moldings such as circular plates (for example with a diameter of 60 mm) by for example injection molding, the thermoplastic ASA composition results in particular in the molding having a greater detected amount of a sterically hindered amine stabilizer (B1) on its surface after just 500 h of artificial weathering in accordance with standard EN ISO 4892 than is present in a molding before artificial weathering, i.e. after 0 h of weathering.

ASA copolymers and blends thereof with other thermoplastic polymers such as polycarbonate or polyamide are widely used in many applications, such as in the automotive industry, the electronics industry or for household goods. The popularity of these thermoplastic polymer compositions can be attributed to their good balance of properties such as good impact strength, their melt flow properties, and high weather resistance. The balance between toughness and stiffness and the weather resistance are becoming increasingly important in polymer moldings. Impact-resistant, multiphase emulsion polymers of the ASA type are known to be particularly UV stable. An important field of application for ASA polymers is unpainted automotive parts in exterior applications such as front grilles or side mirrors, which are often colored black.

In the case of such parts, what automobile manufacturers need, besides the primary material properties such as good impact/thermal properties, is for the surface properties to also exhibit good stability on exposure to UV and weathering over relatively long periods (in practice many thousands of hours). Automotive manufacturers often use standardized laboratory weathering tests to simulate outdoor weathering over a period of years. The appearance of the surface is then typically assessed through changes in surface color and/or in the degree of gloss.

Stabilizers in ASA polymers for use in outdoor applications are combinations of a UV absorber (e.g. Tinuvin® P, benzotriazole derivative) and a low-molecular-weight sterically hindered amine (HALS; hindered amine light stabilizer). High-molecular-weight HALS products such as the commercial product Chimassorb®944 having average molecular weights above 1000 g/mol have also been described; see EP-B 2593510. U.S. Pat. Nos. 4,692,486, 9,701,813, EP-B 2593510, and DE-A 10316198 describe HALS stabilizers for polymers and combinations thereof as UV absorbers and light stabilizers in molding compounds.

In the context of the present invention, it has been found that many known ASA compositions comprising the previously described UV stabilizer formulations are unable to meet the requisite high weather resistance for indoor and outdoor uses.

It has been found that stabilizer combinations (for example Tinuvin® P with Tinuvin® 770, or Tinuvin P® with Tinuvin® 765, or Tinuvin® P with Chimassorb® 944) are insufficient for highly demanding long-term uses of polymer shaped bodies.

The addition of stabilizers of varyingly high molecular weight, with the aim that high-molecular-weight stabilizers migrate more slowly and thus have a more delayed effect than low-molecular-weight stabilizers, is inexpedient in some cases, since migration in polar components, such as styrene-acrylonitrile copolymers, correlates only partially with the molecular weight. What seems to be of importance here is the polarity of the additive and thus also its interaction with the polymer composition to be modified.

Extensive investigations have found that those thermoplastic polymer compositions exhibit particularly high UV stability when, at any time in the artificial weathering of a molding produced therefrom (for example round plates having a diameter of 60 mm and a thickness of 3 mm), they have a minimum amount of sterically hindered amine (HALS) on their surface.

The detectability criterion here is that after x hours of artificial weathering (at least 500 hours, preferably after at least 1000 h, more preferably after at least 1600 h, often after at least 3000 h, and especially after at least 6000 h), the signal intensity of the UV stabilizer detected at the surface is greater than at least 10% of the signal intensity of the “0 sample” (molding made of UV-stabilized molding compound before weathering, 0 h).

The material resistance of a film or of a molding when stored outdoors relates not only to the effect of the UV component of sunlight, but also inter alia to the effects of moisture, temperature fluctuations, pollutants, and wind. Since not all of these influencing variables can be simulated in simple laboratory tests, tests were carried out in accordance with the DIN EN ISO 4892-2013/2014 standard. The accelerated aging of a molding or film by UV light is simulated using filtered xenon-arc radiation. In device weathering, as opposed to device irradiation, the molding is additionally sprayed with water in defined cycles. The DIN EN ISO 4892 standard relates to plastics and artificial irradiation or weathering in devices with xenon arc lamps. The global radiation dose determined for the design of device weathering usually refers to a spectral range of approx. 300-3000 nm. For example, a Q-SUN device (from Q-LAB) can be used, which works with xenon arc radiators. The irradiance E [W/m²] in the device is regulated in accordance with DIN EN ISO 4892-22 using a UV sensor in the 300-400 nm wavelength interval. From E [W/m²] and the irradiation time in hours [h] is derived the radiation dose [kWh/m²] for the specified spectral range.

A proven method when using xenon-arc radiation is assessment of the aging of polymer samples after irradiation based on physical/technological parameters, which is done by comparing unirradiated (0 h) and irradiated (x h) samples, for example in the form of mechanical tests or chemical analyses (for example the content of particular components).

The present invention relates to a thermoplastic acrylate-styrene-acrylonitrile (ASA) copolymer composition that is particularly suitable for the production of moldings, said composition comprising the following components (or consisting of the following components):
10-89.7% by weight, based on the total composition, of a copolymer A1 consisting of:
   A11: 60-70% by weight of at least one optionally substituted styrene,
   A12: 25-35% by weight of acrylonitrile,
   A13: 0-20% by weight of a further copolymerizable monomer;
10-89.7% by weight, based on the total composition, of at least one graft copolymer A2 having an average particle size of 80-800 nm, consisting of:
   A21: 40-90% by weight, based on A2, of at least one rubber-like base substance having T_{g}<0° C., consisting of:
      A211: 70-99.9% by weight, based on A21, of at least one alkyl acrylate,
      A212: 0.1-10% by weight, based on A21, of at least one crosslinking
      monomer containing at least two functional groups,
      A213: 0-29.9% by weight, based on A21, of at least one further copolymerizable monomer,
   A22: 10-60% by weight, based on A2, of at least one graft shell, consisting of
      A221: 60-80% by weight, based on A22, of at least one optionally substituted styrene,
      A222: 20-40% by weight, based on A22, of acrylonitrile,
      A223: 0-20% by weight, based on A22, of at least one further copolymerizable monomer;
0.1-2% by weight, based on the total composition, of at least one sterically hindered amine (HALS) B1;
0-2% by weight, based on the total composition, of at least one sterically hindered amine (HALS) B2 that is different from B1;
0-2% by weight, based on the total composition, especially 0.1-2% by weight, of at least one UV-A absorber B3;
0.1-3% by weight, based on the total composition, of at least one carbon black component CB, and
0-5% by weight, based on the total composition, especially 0.1-5% by weight, of one or more further additives C that is/are different from B1, B2, B3, and CB,
wherein the thermoplastic acrylate-styrene-acrylonitrile copolymer composition after the production of moldings, especially by injection molding, results in at least one sterically hindered amine (B1, B2) being present on the surface of a molding after 500 h of artificial weathering in accordance with standard EN ISO 4892 (2016) in a higher amount than in a molding before the artificial weathering.

The sum of all components A, B, C, and CB of the composition should preferably be 100% by weight.

In the thermoplastic acrylate-styrene-acrylonitrile copolymer composition, it is preferable that the amount (ppm) of sterically hindered amine (B1, B2) at the surface of the molding after 1000 h, preferably after 1600 h, more preferably after 3000 h, is at least twice as high, especially at least three times higher, than in a molding before weathering.

In one embodiment, the thermoplastic ASA copolymer composition contains 0.1-2% by weight, often 0.2% to 1.0% by weight, of at least one sterically hindered amine (B1 and/or B2), selected in particular from the group of sterically hindered monopiperidine derivatives having a molar mass of 400-600 g/mol. Particularly suitable is the product Cyasorb® UV-3853, comprising 2,2,6,6-tetramethyl-4-piperidinyl stearate. As well as 2,2,6,6-tetramethyl-4-piperidinyl stearate, the corresponding 2,2,6,6-tetramethyl-4-piperidinyl palmitate and 2,2,6,6-tetramethyl-4-piperidinyl eicosanate are also suitable, in the form of the individual compounds or as a mixture.

In one embodiment, the thermoplastic ASA copolymer composition contains 0.1-2% by weight of at least two sterically hindered amines (B1 and B2), wherein B1 is selected from the group of sterically hindered monopiperidine derivatives having a molar mass of 400-600 g/mol, in particular Cyasorb® UV-3853, and wherein B2 is selected from the group of sterically hindered piperidine derivatives having a molar mass of >600 g/mol, especially >2000 g/mol. Preference is given to using as B2 poly-{6-[(1,1,3,3-tetramethylbutyl)amino-1,3,5-triazine-2,4-diyl][(2,2,6,6-tetramethyl-4-piperidyl)imino]-1,6-hexanediyl[(2,2,6,6-tetramethyl-4-piperidyl)imino)}, especially Chimassorb® 944. Chimassorb® 119 or Chimassorb® 2020 may also be used.

In one embodiment, the thermoplastic ASA copolymer composition contains 0.1-1% by weight, often 0.2% to 0.8% by weight, of at least one UV-A absorber B3, preferably selected from the group of benzotriazole derivatives having a molar mass of 200-400 g/mol. Tinuvin® P is particularly suitable.

In one embodiment, the thermoplastic ASA copolymer composition contains 0.1-2% by weight, often 0.2-0.8% by weight, of at least one primary antioxidant from the class of sterically hindered phenols.

In one embodiment, the thermoplastic ASA copolymer composition contains as an additional additive component (C) 0.1-2% by weight, often 0.2-0.8% by weight, of at least one secondary antioxidant from the class of phosphite stabilizers. Particularly suitable are tris(nonylphenyl)phosphite and/or Irgafos®168, and/or at least one sulfur stabilizer, especially Irganox® PS 800.

In one embodiment, the thermoplastic acrylate-styrene-acrylonitrile copolymer composition contains 0.2-1.5% by weight, especially 0.2-1% by weight, of a carbon black component CB.

In one embodiment, the thermoplastic ASA copolymer composition contains (approximately) 30-70% by weight, often 30-40% by weight, of copolymer A1 and 20-70% by weight, often 60-70% by weight, of at least one, especially two different, graft copolymer(s) A2. The sum of all components of the composition should be 100% by weight.

In one embodiment the copolymer components A1 and A2 comprise, in the thermoplastic ASA copolymer composition, monomers A11 and A221 selected from the group styrene, α-methylstyrene, and styrene alkylated in the ring.

In one embodiment the graft copolymer component A2 comprises, in the thermoplastic ASA copolymer composition, monomers A211 selected from the group of alkyl acrylates having 1-8, especially 1-4, carbon atoms in the alkyl radical.

In one embodiment the copolymer components A1 and A2 comprise, in the thermoplastic ASA copolymer composition, copolymer components A1 and A2, wherein the monomers A12 and A222 are acrylonitrile and A11 and A221 are styrene.

The invention also provides a process for producing a thermoplastic acrylate-styrene-acrylonitrile copolymer composition for the production of moldings, as described above, wherein the copolymer components A1 and A2 are produced by emulsion polymerization or graft copolymerization and are then combined with the further components B1, B2, CB, and C (and optionally with further components).

The invention also provides a molding produced from a thermoplastic acrylate-styrene-acrylonitrile copolymer composition as described above.

The invention also provides for the use of a thermoplastic acrylate-styrene-acrylonitrile copolymer composition as described above for the production of moldings, especially for automobile parts such as wing mirrors, body panels, radiator grilles, front- and/or back-end parts, parts of lights and light housings, cable sheathings, films, tubing, fibers, profiles, technical moldings, coatings and/or blow moldings.

The components of the composition are elucidated hereinbelow.

### Component A1

Component A1 is used in amounts of 10-89.7% by weight, especially (approximately) 30-70% by weight. Suitable as monomer A11 are vinylaromatic monomers, preferably styrene and/or styrene derivatives, such as preferably α-methylstyrene and styrenes alkylated in the ring, such as for example p-methylstyrene and/or tert-butylstyrene.

Usually acrylonitrile is used as monomer A12, but the following compounds may for example also be used: methacrylonitrile, methyl acrylate, ethyl acrylate, propyl acrylate, methyl methacrylate, ethyl methacrylate, phenylmaleimide, acrylamide, vinyl methyl ether. Preference is however given to using acrylonitrile.

A1 can be produced by generally known methods: see for example DE-A 3149358 (page 9, lines 18-32) and DE-A 3227555 (page 9, lines 18-32). For example, A11, A12, and optionally further copolymerizable monomers A13 undergo copolymerization in bulk, solution, suspension or aqueous emulsion at customary temperatures and pressures in known apparatuses (see Kunststoff-Handbuch [Plastics handbook], Vieweg-Daumiller, volume V (Polystyrol [Polystyrene]), Carl-Hanser, Munich, 1969, page 124.

### Component A2

The graft copolymer component A2 is used in amounts of 10-89.7% by weight, especially (approximately) 20-70% by weight.

Suitable as monomer A211 for the production of the acrylic ester base substance A21 are preferably alkyl acrylates having 1-8 carbon atoms, preferably 4-8 carbon atoms, in the alkyl radical, especially n-butyl acrylate and/or ethylhexyl acrylate. In the production of the graft base A21, the acrylic esters may be used individually or as a mixture.

Particularly suitable as the crosslinker A212 are allyl (meth)acrylate, divinylbenzene, diallyl maleate, diallyl fumarate and/or diallyl phthalate and triallyl cyanurate, especially allyl methacrylate (AMA) and the acrylate ester of tricyclodecenyl alcohol and/or dicyclopentadienyl acrylate.

Examples of possible other copolymerizable monomers A213 that may be used are: α-methylstyrene, methacrylonitrile, methyl methacrylate, ethyl methacrylate, phenylmaleimide, acrylamide, vinyl methyl ether; optionally also methyl acrylate, ethyl acrylate, and propyl acrylate.

Suitable as the vinylaromatic monomer A221 for the production of the graft shell A22 grafted onto the graft base A21 are preferably styrene and/or styrene derivatives, for example styrene, alkyl styrenes, preferably α-methylstyrene, and styrenes alkylated in the ring, such as for example p-methylstyrene and/or tert-butylstyrene.

Examples of polar, copolymerizable unsaturated monomers A222 besides acrylonitrile include also methacrylonitrile.

As possible further copolymerizable monomers A223, the following compounds may for example be used: acrylic acid, methacrylic acid, maleic anhydride, methacrylonitrile, methyl acrylate, ethyl acrylate, propyl acrylate, methyl methacrylate, ethyl methacrylate, phenylmaleimide, acrylamide, vinyl methyl ether.

In a preferred embodiment, the graft copolymer A2 has an average particle diameter (particle size) d₅₀ within a range from 80 to 800 nm, preferably 90 to 700 nm. The particle diameter can for example be set through known suitable measures during production. This is described inter alia in DE-A 2826925.

The average particle diameter d₅₀ can typically be determined by ultracentrifuge measurement (W. Scholtan, H. Lange, Kolloid-Z. u. Z. Polymere 250, pp. 782 to 796, 1972) or else by means of hydrodynamic chromatography HDC (see W. Wohlleben, H. Schuch, “Measurement of Particle Size Distribution of Polymer Latexes”, 2010, editors: L. Gugliotta, J. Vega, pp. 130-153).

In a preferred embodiment, the thermoplastic ASA composition comprises at least two different graft copolymers A2a and A2b, the graft copolymers A2a and A2b differing in their average particle diameter d₅₀. In particular, the graft copolymer A2 comprises at least one of the graft copolymers A2a and A2b, where
graft copolymer A2a has an average particle diameter d₅₀ within a range from 80 to 200 nm (small-particle ASA rubber) and
graft copolymer A2b has an average particle diameter d₅₀ within a range from 300 to 800 nm (large-particle ASA rubber).

It is desirable if the graft copolymer A2b (large-particle ASA rubber) has a narrow particle size distribution, wherein it is favorable when the ratio R=(d₉₀−d₁₀)/d₅₀ is less than 0.3, preferably less than 0.2.

Crosslinked C₁-C₈ alkyl (meth)acrylate polymers suitable as the graft base can be obtained by known processes for producing large-particle dispersions, for example by the seed latex method, see DE 1 911 882. In this method, a small-particle, crosslinked acrylate latex (seed latex) having an average particle diameter d₅₀ within a range from 50 to 180 nm that was obtained by emulsion polymerization of C₁-C₈ alkyl (meth)acrylates, crosslinking monomers, and optionally further comonomers, is typically subjected to further polymerization by addition of further monomers, emulsifier, and optionally buffer substance.

The conditions (cf. Journal of Applied Polymer Science, vol. 9 (1965), pages 2929 to 2938) are typically set so that only the existing latex particles of the seed latex continue to grow, but no new latex particles are formed. An initiator is normally used. The particle size of the resulting graft copolymer A2b (large-particle rubber) can be set in the desired manner especially by varying the quantitative ratio of seed latex to monomers.

The graft copolymer A2 is preferably obtained by emulsion polymerization of styrene and/or α-methylstyrene, and acrylonitrile in the presence of the previously produced graft base. In the production of the compositions of invention, the graft copolymers A2 may be used in combination, in which it is possible to vary the weight ratio of the graft copolymers within wide limits. A2 is preferably a mixture of at least two ASA components, wherein the weight ratio of graft copolymer A2a to graft copolymer A2b is within a range from 90:10 to 10:90, preferably 80:20 to 20:80, and more preferably 20:10 to 10:10.

The graft copolymers A2a and A2b are preferably produced and worked up separately (for example precipitation of the graft copolymers, dewatering of the water-wet graft copolymers, filtration or centrifugation, drying) and then mixed with the thermoplastic copolymer A1 and the further components B, CB, and C.

It is also possible to obtain, by a known agglomeration process, graft copolymers A2 having different particle sizes, especially a bimodal particle size distribution from 80 to 200 nm and from 300 to 800 nm. Graft copolymers having large-sized and small-sized particles are described for example in DE-A 36 15 607. It is also possible to use graft copolymers A2 that comprise two or more different graft shells. Graft copolymers having multistage graft shells are described for example in EP-A 111260 and WO 2015/078751. For the production of the ASA graft polymer components, reference is also made to the experimental section of EP-B 2882806 and EP-B 3039072.

### Components B1, B2, and CB

In addition to the copolymer A1 and graft polymer A2, the thermoplastic ASA compositions of the invention comprise at least one HALS stabilizer B1, optionally a further HALS stabilizer B2, and at least one carbon black component (CB). They often also comprise a UV-A absorber component B3.

Benzotriazole derivatives having a molar mass of 200-450 g/mol, especially 200-300 g/mol, are used in particular as B3. Particularly suitable is Tinuvin® P, especially in an amount of 0.1-2% by weight, often 0.2-1.0% by weight;

Tinuvin® P is 2-(2H-benzotriazol-2-yl)-4-methylphenol (MW 225 g/mol).

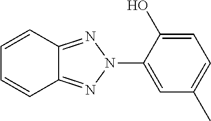 [SMILES: Cc1ccc(O)c(-n2nc3ccccc3n2)c1]

Also in principle suitable as component B3 are the following benzotriazole derivatives:

Tinuvin®320, Tinuvin®326, Tinuvin®327, Tinuvin®328, Tinuvin®329, and Tinuvin®350, in each in case in amounts within the above ranges.

All customary UV-A stabilizers can in principle be added to the composition as further light protection components, for example compounds based on benzophenone, cinnamic acid, organic phosphites and/or phosphonites.

Various amine stabilizers can in principle be used as HALS stabilizer component B1 and/or B2. The mixture of 2,2,6,6-tetramethyl-4-piperidinyl octadecanate and 2,2,6,6-tetramethyl-4-piperidinyl eicosanate has however proved particularly suitable. One product is marketed as Cyasorb® UV-3853 (Solvay, MW approx. 520 g/mol, m.p. 30° C.).

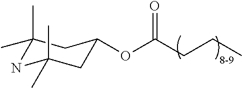

The individual components of this mixture are per se also suitable.

As component B2, the oligomeric Chimassorb® 944 can be used as an additional HALS component; this is poly[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]], having a MW of 2000-3100 g/mol.

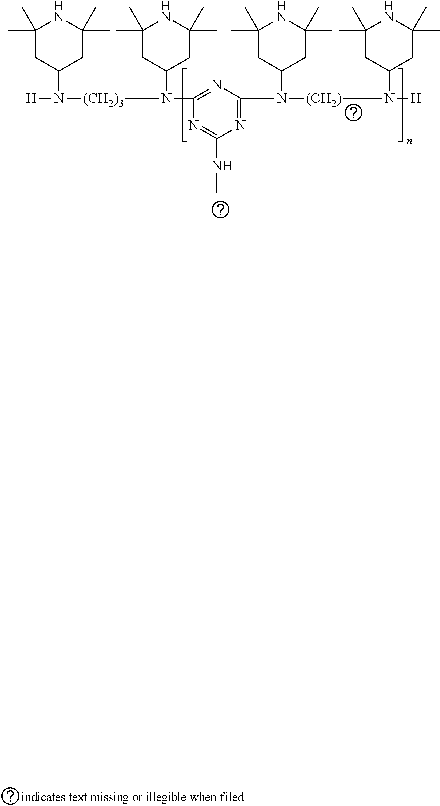

The further component carbon black (CB) is present in the thermoplastic composition in a content of 0.1% to 3% by weight, often 0.2% to less than 1.5% by weight, for example 0.3% to 1.0% by weight. The stated amount refers to the carbon black itself.

Black Pearls® 770 or Black Pearls® 880 from Cabot are for example suitable. The CB component may also be in the form of a masterbatch, for example in component A1 (e.g. SAN). The masterbatch contains for example only 25% by weight of the carbon black and 75% by weight of SAN matrix.

### Component C

The customary auxiliaries and/or additives (different from component (B)) may be used as further additives (C), for example color pigments, emulsifiers such as alkali metal salts of alkyl or alkylaryl sulfonic acids, alkyl sulfates, fatty alcohol sulfonates, salts of higher fatty acids having 10-30 carbon atoms or resin soaps, polymerization initiators such as for example customary persulfates, for example potassium persulfate, or known redox systems, polymerization auxiliaries such as for example customary buffer substances that can be used to set a pH of preferably 6 to 9, for example sodium bicarbonate and/or sodium pyrophosphate, and/or molecular weight regulators, for example mercaptans, terpinols and/or dimeric α-methylstyrene.

The molecular weight regulators are used in an amount of 0% to 3% by weight based on the weight of the reaction mixture.

Often the compositions comprise further additives (C), for example dyes and/or pigments, plasticizers, antistats, lubricants, blowing agents, adhesion promoters, fillers, surface-active substances, flame retardants, stabilizers inter alia against oxidation, hydrolysis, heat or discoloration, and/or reinforcing agents.

These additives may be employed either during production of the compositions (molding compounds) or else added to components A1 and/or A2 during production of the mixture.

Examples of suitable lubricants are hydrocarbons such as oils, paraffins, PE waxes, PP waxes, fatty alcohols having 6 to 20 carbon atoms, ketones, carboxylic acids such as fatty acids, montanic acid or oxidized PE wax, carboxamides and carboxylic esters, for example with alcohols, ethanol, fatty alcohols, glycerol, ethanediol, and pentaerythritol, and long-chain carboxylic acids as the acid component.

Employable as additives (C) are customary antioxidants such as phenolic antioxidants, for example alkylated monophenols, as well as esters and/or amides of 3-(3,5-di-tert-butyl-4-hydroxyphenyl)propionic acid. Examples are antioxidants from EP-A 698637 and EP-A 669367 and from Plastics Additives Handbook (Zweifel, Maier, Schiller, 6th edition, Carl Hanser Verlag, Munich 2009, pages 1 to 137). Specifically, it is possible to use for example as phenolic antioxidants 2,6-di-tert-butyl-4-methylphenol, pentaerythritol tetrakis[3-(3,5-di-tert-butyl-4-hydroxyphenyl)propionate], and N,N′-di-[3-(3,5-di-tert-butyl-4-hydroxyphenyl)propionyl]hexamethylenediamine, for example. The stabilizers mentioned may be used individually or in combination. Stabilizers other than components B1, B2, B3 may also be used.

### Other Polymers

It is also possible to add to the above-described ASA compositions further (compatible) thermoplastic plastic components, for example polyesters (e.g. polyethylene terephthalate, polybutylene terephthalate), polycarbonate (PC), polyamide, polyoxymethylene, polystyrene, polyethylene, polypropylene and/or polyvinyl chloride. In general, their amount is smaller than the amount of copolymers A1+A2. Typical examples are blends of ASA, as described, and PC.

### Processing of the Compositions

The compositions of the invention may for example be pelletized or granulated, or processed by generally known methods, for example by extrusion, injection molding or calendering, into automotive moldings, cable sheathings, films, tubing, fibers, profiles, shoe shells, shoe soles, technical moldings, consumer goods, shaped bodies of all kinds, coatings, bellows, animal ear tags and/or blow moldings.

In the injection molding employed in the present case for the production of moldings, the thermoplastic ASA composition is liquefied at high temperature in a conventional injection molding machine and injected into a mold (e.g. cylinder) under pressure. In the mold, the polymer molding compound transitions into the solid state through cooling and is removed as a finished molding and tested further. In the injection phase, the injection unit is moved to the clamping unit, the nozzle is pressed against it, and high pressure is applied to the screw from the reverse side. The polymer melt is pressed through the open nozzle of the injection mold into the molding cavity.

The invention is elucidated in more detail by the examples and claims that follow:

### EXAMPLE 1 PRODUCTION OF THE COMPOSITION

### Component A1

As a copolymer, a SAN from INEOS Styrolution was produced with 67% by weight of styrene as A11 and 33% by weight of acrylonitrile as A12, having viscosity number VN (measured in 0.5% toluene solution at RT): 80 ml/g. Component A1 was produced by a solution polymerization process, see Kunststoff-Handbuch [Plastics handbook], Vieweg-Daumiller, volume V (Polystyrol [Polystyrene]), Carl-Hanser, Munich, 1969, page 124.

### ASA Components A2

Employed as a first graft copolymer A2a was an ASA produced (in accordance with DE 3135251, page 12, line 21) using small acrylate rubber particles from INEOS Styrolution (graft rubber LS2). The graft copolymer A2a has an average particle diameter d₅₀ in the range of less than 200 nm.

Employed as a second graft copolymer A2b was an ASA produced (in accordance with EP-B 3039072, page 9) using larger acrylate rubber particles from INEOS Styrolution (graft rubber LS5). Graft copolymer A2b has an average particle diameter d₅₀ in the range of about 500 nm.

Each of the A2a and A2b graft copolymer components was in separate experiments intimately mixed with SAN component A1 in a weight ratio of 40:60 in an extruder (ZSK 30 twin-screw extruder from Werner & Pfleiderer) at a temperature of 230° C.

### Other Components

Component B1: HALS stabilizer Cyasorb 3853, amount 0.5% by weight
Component B2: HALS stabilizer Chimassorb 944, amount 0.5% by weight
Component B3: UV absorber: Tinuvin P, amount 0.5% by weight
Component C: Black Pearls 770 pigment carbon black, amount 0.5% by weight.

For comparison purposes, the standard commercial product Tinuvin® 765, a mixture of bis(1,2,2,6,6-pentamethyl-4-piperidyl) sebacate and methyl 1,2,2,6,6-pentamethyl-4-piperidyl sebacate (508 g/mol and 370 g/mol), was investigated as a further additive component (C).

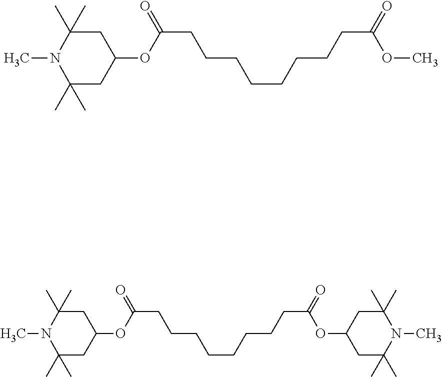

For comparative tests, the commercial product Tinuvin® 770, namely bis(2,2,6,6-tetramethyl-4-piperidyl) sebacate (MW 481 g/mol), was tested as a further additive component (C).

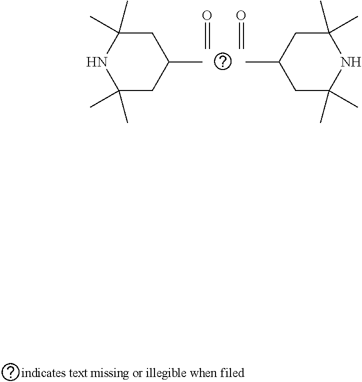

### EXAMPLE 2 CHARACTERIZATION OF THE COMPOSITIONS

The compositions (with components in parts by weight) and measured physical properties are summarized in Table 1. Example 1 is inventive and has advantageous properties.

TABLE 1

| | Comparison 1 | Comparison 2 | Comparison 3 | Ex. 1 |
|---|---|---|---|---|
| Component A1 (copolymer) | 32 | 32 | 32 | 32 |
| Component A2a (graft | 21 | 21 | 21 | 21 |
| copolymer LS2) | | | | |
| Component A2b (graft | 11 | 11 | 11 | 11 |
| copolymer LS5) | | | | |
| Component A22 (graft shell) | 36 | 36 | 36 | 36 |
| Component B3 Tinuvin P | 0.5 | 0 | 0.5 | 0.5 |
| (absorber) | | | | |
| Tinuvin 770 (HALS) | 0.5 | 0.5 | | |
| Component B1 Cyasorb | | | | 0.5 |
| 3853 (HALS) | | | | |
| Chimassorb 944 (HALS) B2 | | | 0.5 | |
| Component CB in the form of | 0.5 (2.0) | 0.5 (2.0) | 0.5 (2.0) | 0.5 (2.0) |
| carbon black Black Pearls | | | | |
| 880 | | | | |
| Detectability of at least one | Yes | Yes | No | Yes |
| HALS after 0° h of ISO 4892- | | | | |
| 2 weathering | | | | |
| Detectability of at least one | No* | No* | No | Yes |
| HALS after 500 h of | | | | |
| ISO 4892-2 weathering | | | | |
| Surface gloss after 4000 h | <20 | <20 | <40 | 65 |
| Color deviation delta E | 3 units | 3 units | 3 units | 2 units |

*“No” means: washed off by ISO 4892-2 simulated rain cycle. Detectability either not possible or well below the amount detected with “Yes”.

In the examples, component CB is used in the form of a batch containing 25% by weight of carbon black and 75% by weight of SAN copolymer. A stated amount of 0.5 parts by weight therefore corresponds effectively to 2.0 parts by weight of the batch composition.

The Charpy notched impact strength of the moldings after injection molding is measured in accordance with ISO 179 1eA at 23° C. and an injection molding temperature of 220° C. In example 1 it is still high even after weathering. A high notched impact strength is achieved even at low processing temperatures and this remains good even after weathering.

The average particle size is determined with the aid of an ultracentrifuge according to the method of Scholtan, W. and Lange, H. Colloid-Z. u. Z. Polymere (1972). The ultracentrifuge measurement gives the integral mass distribution of the particles in a sample. The average particle diameter d₅₀ is defined as the diameter at which 50% by weight of the particles have smaller diameters and 50% by weight of the particles have larger diameters.

The Xenotest (artificial weathering) is carried out in accordance with ISO 4892-2. This part of EN ISO 4892 specifies the methods for exposing test specimens to heat and water in a xenon-arc radiation apparatus in order to simulate the weathering effects that occur when materials are exposed to global radiation or to global radiation behind window glass in real end-use environments. The test specimens (round disks, 60 mm diameter) are exposed to filtered xenon-lamp radiation under controlled environmental conditions (temperature, humidity and/or wetting). The preparation of the test specimens and the evaluation of the results are dealt with in other international standards intended for specific materials. General guidance is given in ISO 4892-1.

The surface gloss is measured on injection-molded components at an angle of 60° using a conventional measuring device in accordance with DIN EN ISO 2813 (2015).

The deviation in color DE is measured on injection-molded components using a standard measuring device for measuring colors on motor vehicle parts (DIN 6174).

Tables 1 and 2 show a synergistically improved effect for the ASA composition of the invention. After the moldings had undergone weathering, the HALS component (B1) was detected in an increased amount on the surface in the case of the composition of the invention (example 1), in contrast to the three comparative compositions.

TABLE 2
(Analytical detection of HALS on the surface of the
ASA molded test specimen after weathering (measured
on round disks, relative signal intensity)

Rel. signal intensity

| | 0 h | 500 h | 1000 h | 1600 h |
|---|---|---|---|---|
| Tinuvin ® 770 (HALS) | 1.0 | — | — | — |
| Cyasorb ® 3853 C16 | 1.0 | 5.5 | 12.1 | 16.2 |
| chain (HALS) | | | | |
| Cyasorb ® 3853 C18 | 1.0 | 2.0 | 4.3 | 5.8 |
| chain (HALS) | | | | |
| Chimassorb ® 944 | — | — | — | — |
| (HALS) (no detection) | | | | |

The relative signal intensities correspond to the amounts of stabilizer present on the corresponding surface of the round ASA disk in each case.

Chimassorb® 944 was not detected on the surface of the test specimens either before or after weathering. Although the additive Tinuvin® 770 was still detected on the surface of the test specimens (round disks) before weathering, it was already no longer detectable after 500 hours. It is assumed that it migrates rapidly to the surface, but is then leached out during exposure to artificial weathering.

In contrast, both components of Cyasorb® 3853 were detected in larger amounts on the surface of the moldings as the duration of weathering increases, which confirms the improved stabilization of these ASA compositions.

The measurements are based on secondary-ion mass spectrometry (SIMS), a surface chemistry method commonly used for the determination of individual substances on the surface of moldings by those skilled in the art of polymers. Also detected in the moldings of the invention is a markedly higher surface gloss and the deviation in color delta E is significantly smaller after weathering.

1-15. (canceled)

16. A thermoplastic acrylate-styrene-acrylonitrile (ASA) copolymer composition for the production of moldings, the composition comprising the following components:
A1: 10-89.7% by weight of a copolymer A1 consisting of:
A11: 60-70% by weight of at least one optionally substituted styrene,
A12: 25-35% by weight of acrylonitrile, and
A13: 0-20% by weight of a further copolymerizable monomer;
A2: 10-89.7% by weight of at least one graft copolymer A2 having an average particle size of 80-800 nm, consisting of:
A21: 40-90% by weight of at least one rubber-like base substance having T_{g}<0° C., consisting of:
A211: 70-99.9% by weight of at least one alkyl acrylate,
A212: 0.1-10% by weight of at least one crosslinking monomer containing at least two functional groups, and
A213: 0-29.9% by weight of at least one further copolymerizable monomer; and
A22: 10-60% by weight of at least one graft shell, consisting of:
A221: 60-80% by weight of at least one optionally substituted styrene,
A222: 20-40% by weight of acrylonitrile, and
A223: 0-20% by weight of at least one further copolymerizable monomer;
B1: 0.1-2% by weight of at least one sterically hindered amine (HALS) B1;
B2: 0-2% by weight of at least one sterically hindered amine (HALS) B2 that is different from B1;
B3: 0-2% by weight of at least one UV-A absorber B3;
CB: 0.1-3% by weight of at least one carbon black component CB; and
C: 0-5% by weight of one or more further additives C that is/are different from B1, B2, B3, and CB,
wherein the thermoplastic acrylate-styrene-acrylonitrile copolymer composition after the production of moldings results in at least one sterically hindered amine (B1, B2) being present on the surface of a molding after 500 h of artificial weathering in accordance with standard EN ISO 4892 in a higher amount than in a molding before the artificial weathering.

17. The thermoplastic acrylate-styrene-acrylonitrile copolymer composition for the production of moldings of claim 16, wherein the amount (ppm) of sterically hindered amine (B1, B2) at the surface of the molding after 1000 h is at least twice as high than in a molding before weathering.

18. The thermoplastic acrylate-styrene-acrylonitrile copolymer composition for the production of moldings of claim 16, wherein the composition contains 0.1-2% by weight of at least one sterically hindered amine (B1 and/or B2) selected from the group of sterically hindered monopiperidine derivatives having a molar mass of 400-600 g/mol comprising 2,2,6,6-tetramethyl-4-piperidinyl stearate.

19. The thermoplastic acrylate-styrene-acrylonitrile copolymer composition for the production of moldings of claim 16, wherein the composition contains 0.1-2% by weight of at least two sterically hindered amines (B1 and B2), wherein B1 is selected from the group of sterically hindered monopiperidine derivatives having a molar mass of 400-600 g/mol, and wherein B2 is selected from the group of sterically hindered piperidine derivatives having a molar mass of >600 g/mol.

20. The thermoplastic acrylate-styrene-acrylonitrile copolymer composition for the production of moldings of claim 16, wherein the composition contains 0.1-1% by weight of at least one UV-A absorber B3, selected from the group of benzotriazole derivatives having a molar mass of 200-400 g/mol.

21. The thermoplastic acrylate-styrene-acrylonitrile copolymer composition for the production of moldings of claim 16, wherein the composition contains 0.1-2% by weight of at least one primary antioxidant from the class of sterically hindered phenols.

22. The thermoplastic acrylate-styrene-acrylonitrile copolymer composition for the production of moldings of claim 16, wherein the composition contains as an additional component (C) 0.1-2% by weight of at least one secondary antioxidant from the class of phosphite stabilizers and/or at least one sulfur stabilizer.

23. The thermoplastic acrylate-styrene-acrylonitrile copolymer composition for the production of moldings of claim 16, wherein the composition contains 0.2-1.5% by weight of a carbon black component CB.

24. The thermoplastic acrylate-styrene-acrylonitrile copolymer composition for the production of moldings of claim 16, wherein the composition contains 30-70% by weight of copolymer A1 and 20-70% by weight of at least one graft copolymer(s) A2.

25. The thermoplastic acrylate-styrene-acrylonitrile copolymer composition for the production of moldings of claim 16, wherein, in the copolymer components A1 and A2, the monomers A11 and A221 are selected from the group styrene, α-methylstyrene, and styrene alkylated in the ring.

26. The thermoplastic acrylate-styrene-acrylonitrile copolymer composition for the production of moldings of claim 16, wherein, in the graft copolymer component A2, the monomers A211 are selected from the group of alkyl acrylates having 1-8 carbon atoms in the alkyl radical.

27. The thermoplastic acrylate-styrene-acrylonitrile copolymer composition for the production of moldings of claim 16, wherein, in the copolymer components A1 and A2, the monomers A12 and A222 are acrylonitrile and A11 and A221 are styrene.

28. A process for producing a thermoplastic acrylate-styrene-acrylonitrile copolymer composition for the production of moldings of claim 16, wherein the copolymer components A1 and A2 are produced by emulsion polymerization or graft copolymerization and are then combined with the further components B1, B2, CB, and C.

29. A molding produced from a thermoplastic acrylate-styrene-acrylonitrile copolymer composition of claim 16.

30. The molding of claim 29, wherein the molding is an automobile part.

31. The molding of claim 30, wherein the automobile part is selected from the group consisting of wing mirrors, body panels, radiator grilles, front- and/or back-end parts, parts of lights and light housings, cable sheathings, films, tubing, fibers, profiles, technical moldings, coatings, and/or blow moldings
